(19) United States
(12) Patent Application Publication
(10) Pub. No.: US 2025/0277344 A1
(43) Pub. Date: Sep. 4, 2025

(54) ROAD PAVER COMPRISING A MATERIAL HOPPER FOR RECEIVING PRODUCTION MATERIAL

(71) Applicant: JOSEPH VÖGELE AG, Ludwigshafen/Rhein (DE)

(72) Inventor: Thomas SCHMIDT, Plankstadt (DE)

(73) Assignee: JOSEPH VÖGELE AG, Ludwigshafen/Rhein (DE)

(21) Appl. No.: 19/064,082

(22) Filed: Feb. 26, 2025

(30) Foreign Application Priority Data
Feb. 29, 2024 (EP) 24160579.9

(51) Int. Cl. E01C 19/20

(52) U.S. Cl. CPC E01C 19/20

(57) ABSTRACT

A road paver includes a material hopper for receiving production material, wherein the material hopper includes an outer boundary that at least partially separates an interior space of the material hopper from the surroundings. The material hopper may be loaded with production material, for example by a feeder vehicle. The boundary includes a multi-component flap for closing the material hopper, wherein a first movable component of the flap in an open position is positioned lower than a second movable component of the flap in an open position, and wherein a movement of the first component and the second component from the open position into a closed position, in which the material hopper is closed, is at least partially motion-coupled.

### CROSS-REFERENCE TO RELATED APPLICATIONS

This application claims foreign priority benefits under 35 U.S.C. § 119 (a)-(d) to European patent application number EP 24160579.9, Feb. 29, 2024, which is incorporated by reference in its entirety.

### TECHNICAL FIELD

The present disclosure relates to a road paver including a material hopper for receiving production material, as well as to a combination of a feeder vehicle and a road paver, and a method for loading a material hopper of a road paver.

### BACKGROUND

Road pavers are sufficiently known from the prior art. These include a material hopper that may be loaded with production material for producing the road surface, for example using a feeder vehicle such as a truck. For this purpose, the material hopper is filled with the production material and the production material is transported from the material hopper within the road paver to the screed, where it is dispensed as a road surface.

It is known that the production material must have a certain minimum temperature when be applied, otherwise it is difficult to prepare the road surface. In order to avoid or at least reduce the cooling of the production material in the material hopper, it is also known to configure the boundary surfaces of the material hopper so as to be foldable or generally movable, thereby enabling the material hopper to be loaded with production material in an open position and subsequently to move the material hopper or its side walls into a closed position, in which at least the heat transfer from production material to the ambient air is partially reduced.

Previously known foldable material hoppers, however, may be disadvantageous in that a loading truck may collide with side walls of the material hopper. This is particularly the case if the truck includes a trailer coupling, which is usually lower than the loading area of the truck which the production material is loaded on.

### SUMMARY

Based on the known state of the art, a technical problem to be solved is to provide a road paver that allows a reliable loading with production material, while reducing the risk of damage to the material hopper.

This problem is addressed by the road paver according to claim 1 and the combination of a feeder vehicle and a road paver according to claim 13, as well as a method for loading a material hopper of a road paver according to claim 14. Advantageous further embodiments of the disclosure are included in the dependent claims.

The road paver according to the disclosure includes a material hopper for receiving production material, wherein the material hopper includes an outer boundary that at least partially separates the interior of the material hopper from the surroundings, and the material hopper may be loaded with production material, for example by means of a feeder vehicle, wherein the boundary includes a multi-component flap for closing the material hopper, a first movable component of the flap being positioned lower in an open position than a second movable component of the flap in an open position, and wherein movement of the first component and the second component from the open position to a closed position, in which the material hopper is closed, is at least partially motion-coupled.

Considering an example of a material hopper in the form of a cube, the multi-component flap may, for example, be part of the side surface of the cube. In the open position, it extends out of the volume of the cube and in the closed position, the multi-component flap forms part of the side surface. It is therefore understandable that the multi-component flap defines the interior space to a greater extent in the closed position than in the open position. In general, the interior space may be understood as the volume that is defined by the material hopper in the closed position of the multi-component flap and, if applicable, of other movable parts of the outer boundary.

The fact that the first movable component in the open position is positioned lower than the second movable component of the flap in the open position is to be understood within the meaning of the disclosure such that at least a part of the first component, preferably a part of the first component pointing away from the interior space of the material hopper, has a lower upper boundary than the second movable component. In this case, the first movable component in the open position does not have to be positioned completely lower than the second movable component. At least partially lower positioning is also included.

Positioning the first movable component in a position lower than the second movable component results, on the one hand, in a reliable loading of the material hopper with reduced risk of damage and, on the other hand, in a reliable closing of the material hopper with reduced heat loss of the production material.

It may be considered that the first component has a first upper edge of a first outer boundary surface and the second component has a second upper edge of a second outer boundary surface, wherein in the open position the first upper edge is positioned lower than the second upper edge. The first upper edge or the second upper edge may be straight lines, but may also be curved. In the case of a curved upper edge, the second upper edge may preferably be positioned higher or at most at the same height as the first upper edge at every point. This prevents production material from falling out in the vicinity of the second upper edge.

In one embodiment, the first component is rotatably mounted for movement from the open to the closed position about a first axis of rotation and the second component is rotatably mounted for movement from the open to the closed position about a second axis of rotation. By rotating the first and second components from the open to the closed position, dropping out of production material may be avoided, in particular if the rotation causes an upward movement of the first and second components, so that the production material slides into the interior space of the material hopper.

The first axis of rotation and the second axis of rotation may be parallel, or the first axis of rotation and the second axis of rotation may form an angle with each other, or the first axis of rotation and the second axis of rotation may be identical. By configuring the first and second axes of rotation to be parallel, the second component may be reliably carried along with the first component more. The configuration of first and second axes of rotation enclosing an angle may be preferred to prevent production material from dropping out.

The first component may include a follower that may engage the second component and drive the second component with the first component. In this way, the second component may mechanically drive along with the movement of the first component, thereby reducing a risk of failure.

It may be considered that the second component includes two flap elements arranged on opposite sides of the first component. The lower-positioned first component is thus surrounded by higher-positioned flap elements, so that, on the one hand, the risk of damage during loading is minimized and, on the other hand, the inadvertent dropping out of production material in an area outside the first component is avoided.

The movement of the first component and/or the movement of the second component may be carried out by a drive element. The drive element may include a hydraulic drive element, a mechanical drive element or an electrical drive element. In this embodiment, the coupling of movements between the first component and the second component may be realized in particular by a suitable controller, for example with the aid of a control unit in the form of a computer with associated storage. This enables movement of the first and second components from the open to the closed position in a more flexible manner, so that, for example, it is possible to react flexibly to different types of feeder vehicles and corresponding requirements.

It may be considered that the maximum distance of a point of the first component in the open position to the ground is less than 50 cm, or less than 45 cm, or less than 40 cm, or less than 30 cm. The distance from the ground is measured here with the road paver being normally positioned on a flat surface. The small distance between the uppermost point and the ground ensures that, for example, a component of the feeder vehicle, such as a trailer coupling, may still extend above the first component into the interior space of the material hopper. This prevents collisions between the feeder vehicle or parts thereof and the material hopper, thus avoiding damage.

In one embodiment, the first component and the second component are motion-coupled to each other in such a way that a movement of the first component along a first distance from the open to the closed position takes place without the second component moving at the same time, wherein a movement of the first component over a second distance covered after the first distance from the open to the closed position takes place with the second component moving at the same time.

The first distance may, for example, be chosen such that after covering this distance, the first component is at the same height as the second component. If both are then moved in combination in the direction of the closed position, the production material is prevented from dropping out. In this embodiment, but also in all other embodiments, it may be provided in particular that the first component and the second component are arranged relative to one another in any position between the open position and the closed position, including the open and closed positions, in such a way that there is no gap therebetween, which production material may pass through.

It may be provided that the first component includes a flexible or movable element which, in the open position of the first component, extends at least partially in the vertical direction and may be tilted by force in the direction of the interior space of the material hopper. The flexible element may, for example, be a rubber strip. The movable element may, for example, be a flap or a rotatable metal plate or a plate made of another material, preferably the same material as the material which the material hopper is made of. The flexible or movable element, on the one hand, prevents the production material from falling out and, on the other hand, may further reduce the risk of damage.

The first component and/or the second component may include a surface that, in the open position, is inclined towards the interior space. The surface may be understood, for example, as the base of the respective component. By arranging this surface in such a way that it is inclined towards the interior space in the open position (i.e., slopes down towards the interior space), it is ensured that production material dumped on this surface falls into the interior space of the material hopper or at least falls into the interior space of the material hopper when the first or second component moves.

According to the disclosure, there is also provided a combination of a feeder vehicle and a road paver according to one of the preceding embodiments, wherein the feeder vehicle may supply production material to the material hopper, and during the supply of production material, the flap may be arranged in the open position and after the supply of production material, it may be brought into the closed position. This combination of feeder vehicle and road paver ensures reliable loading of a material hopper with production material at reduced risk of damage to the feeder vehicle and the material hopper.

Furthermore, there is provided a method for loading a material hopper of a road paver, according to one of the preceding embodiments, with production material, wherein the method includes positioning the flap in the open position, subsequently positioning a feeder vehicle for supplying production material and supplying production material to the material hopper, at least partially moving the feeder vehicle away from the material hopper and then moving the flap into the closed position. This method allows reliable loading of the material hopper with production material while at the same time reducing the risk of damage to the feeder vehicle and the road paver, in particular to the material hopper.

### BRIEF DESCRIPTION OF THE DRAWINGS

FIG. 1 shows a road paver according to one embodiment.

FIG. 2 shows a schematic view of a material hopper.

FIGS. 3 to 5 show an embodiment of a movement sequence when moving the multi-component flap from the open to the closed position.

### DETAILED DESCRIPTION

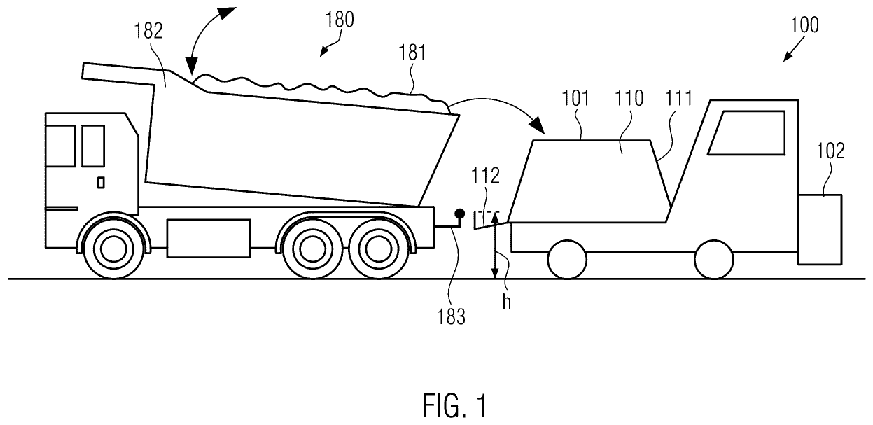

FIG. 1 shows a schematic view of a combination of a road paver 100 and a feeder vehicle 180. In the embodiment shown here, the feeder vehicle 180 is configured as a truck with a receiving area 182, in which production material (e.g., paving material) 181 is stored for feeding the road paver 100. Other embodiments are also conceivable.

The road paver 100 includes a material hopper 101 into which the production material 181 may be introduced from the feeder vehicle. The production material may be stored in this hopper and, for example, fed to the screed 102 at the other end of the road paver 100 for application to the road being constructed. The exact configuration of the road paver 100 is not limited and may be of any known type.

The material hopper 101 is essentially configured so as to include an outer boundary 111 which at least partially separates the interior space 110 of the material hopper from the surroundings. The interior space of the material hopper is to be understood as the volume of the material hopper that is enclosed by the outer boundary 111 in its closed state, as explained below. The outer boundary may, for example, be formed from a multiplicity of movable and/or immovable metal plates or may include the same. In this case, the material hopper does not have to be configured in such a way that the interior space 110 is completely surrounded by the outer boundary 111, but may also include an opening at the top, for example.

According to the disclosure, it is further provided that the boundary includes a multi-component flap 112, which is shown here only schematically and is discussed in more detail in the further embodiments, and which may be used as part of the boundary to at least partially close the material hopper. The multi-component flap 112 is configured to be movable and, in the open position shown here, the multi-component flap is preferably arranged in such a way that at least one part of the multi-component flap (as described below, a first movable component of the multi-component flap) is positioned at a height h above the ground or ends at a height h above the ground, which is less than the height at which a second component of the multi-component flap is positioned in the open position. This allows a component 183 of the feeder vehicle 180 to enter the material hopper without damaging the material hopper and in particular the multi-component flap. The component 183 of the feeder vehicle 180 may, for example, be a trailer coupling that extends to the rear of the feeder vehicle 180 and is usually arranged below the receiving area 182 for the production material 181.

The multicomponent flap 112 according to the disclosure enables the feeder vehicle 180 to approach the road paver 100 as closely as possible without damaging the material hopper 101, so that the material may be introduced into the material hopper with as little loss as possible and without damaging the material hopper or the feeder vehicle.

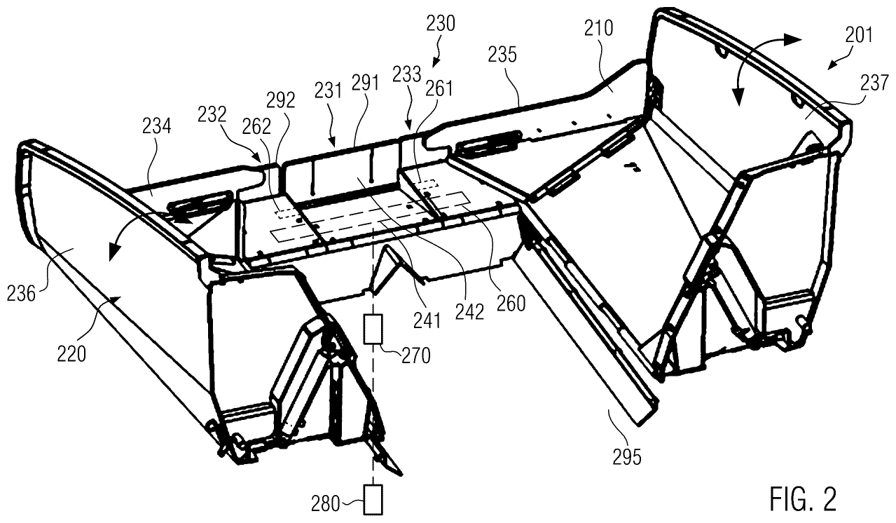

FIG. 2 shows a schematic view of a material hopper 201. The material hopper includes as an outer boundary 220 a plurality of at least partially movable components. For example, side surfaces 236 and 237 are provided which may be moved along the illustrated double-arrow directions in order to open or further close the material hopper. These side surfaces 236 and 237 may be configured so as to be liftable and/or pivotable in the direction of the interior space of the material hopper, for example in order to lift the production material in the direction of the center of the material hopper 201 and to supply it more reliably to a discharge area 295, in which an auger or a scraper belt may be arranged.

The outer boundary 220 may also include the wing surfaces 234 and 235 shown here in a part 210 of the material hopper that points to a feeder vehicle not shown here. This configuration is not mandatory and is to be understood merely as an example. These wing surfaces may also be movable and, in particular, may be arranged in a foldable and/or rotatable manner in order to be moved from an open position into a closed position, in which they delimit the interior space of the material hopper.

According to the disclosure, the material hopper 201 further includes a multi-component flap 230. This is formed here by a first movable component 231 and at least one second movable component 233. The first movable component may be configured as a center component, such as a center plate, and the second movable component may include at least two flap elements 232 and 233 arranged on opposite sides of the first movable component. While the second component is hereinafter referenced with two reference characters, it is understood that the second component may also be configured as a single piece, for example, it may include one flap element 232 or 233 only.

According to the disclosure, it is considered that the first movable component 231 of the multi-component flap 230 is positioned lower in the open position shown here than the second movable component 232, 233 of the flap in the open position, i.e., in the position in which the multi-component flap does not close the material hopper.

Furthermore, the disclosure provides that the multi-component flap 230 is movably arranged so that a movement of the first component and the second component from the open position to the closed position may take place, wherein this movement is motion-coupled. The motion-coupling means that the first component 231 and the second component 232, 233 are moved at least partially together, i.e., simultaneously, during the entire movement from the open to the closed position or vice versa. This may involve the movement of the first component also causing a movement of the second component. While at least partially simultaneous movement is provided, this is not necessarily synonymous with the same movement amplitude of the first and second components. The first and second components may therefore, for example, be moved over different distances despite the coupling of the movement.

In the embodiment shown in FIG. 2, the coupling of the movement of the first and second components is realized by the first component 231 having a follower 261, 262 that may engage the second component 232 or 233 and may thus drive the second component during a movement of the first component. The follower may, for example, be configured as a metal finger from the first component in the direction of the second component. Other configurations are also conceivable here. Not shown here, but optionally present, the second component may include a guide for the follower 261 or 262, so that the follower may be moved along in the guide. This ensures a reliable coupling of movements.

This type of motion-coupling between the first and second components is a purely mechanical movement coupling, whereby it may be envisaged that the first component 231 is actively driven between the open and closed position, for example via a drive element 270. The follower 261, 262 then causes the second component to move, motion-coupled with the movement of the first component.

Alternatively, however, it may also be provided that, instead of a single drive element 270 for the first component 231, there is provided a drive element 270 for the first component 231 and a drive element (not shown separately here) for the second component 232, 233. A control unit 280, for example in the form of a computer or a processor with an associated memory, may then be configured so as to enable control of the respective drive elements in such a way that the first component and the second component may be moved in a manner that is at least partially motion-coupled. It is particularly advantageous that the movement and arrangement of the first component and the second component is such that no gap is formed between the first component and the second component, either in the open or closed position and preferably at no point in between. This prevents the production material from falling out.

The drive element 270 may be of any design, but preferably embodiments of the drive element are configured as a hydraulic drive element, for example in the form of a pneumatic cylinder, or a mechanical drive element, for example in the form of a shaft connected to the first and second components, or an electrical drive element, for example in the form of an electric drive or servomotor. The use of separate drive elements for the first component and the second component, in combination with a corresponding control unit 280, allows flexible control of the movement and, in particular, control of the positioning of the first component in the open position, for example depending on the height of a trailer coupling of the feeder vehicle. If the trailer coupling or another component of the feeder vehicle that extends into the material hopper is positioned higher, it may be sufficient to position the first component less deeply. In particular, in the case of a rotatable first component (see below), this may facilitate the sliding of production material into the interior space of the material hopper, while still keeping the risk of damage to the material hopper and the feeder vehicle low.

In principle, it may be provided that the movement of the first component and the second component between the open and closed position takes place about an axis of rotation 260, which is only shown schematically here. The first component and the second component are therefore tilted at least about the axis of rotation 260 in order to be moved back and forth between the open and closed position.

It may be the case that the first component and the second component are mounted so as to be rotatable about the same axis of rotation 260. Alternatively, it may be the case that the axes of rotation of the first component and the second component do not coincide but are parallel to one another. For example, the axis of rotation of the second component may be offset in the direction of the interior space compared to the axis of rotation 260 of the first component, by up to 10 cm or by up to 20 cm.

Alternatively, it may also be provided that these axes of rotation enclose an angle with each other. Enclosing an angle may be particularly preferred here, especially to avoid gap formation, for example by moving the first component or the second component partially behind the other component, so that gap formation may be avoided.

In the embodiment shown in FIG. 2, the first component 231 is formed in two parts. This is not mandatory and other embodiments, in particular a one-piece design of the first (and/or the second component) are conceivable. In the embodiment shown here, the first component 231 includes a surface 241, which may extend essentially horizontally or at a slight incline. This surface may, for example, serve as a receiving surface for the production material.

Furthermore, the first component includes a flexible or movable element 242, which, in the embodiment shown here in FIG. 2, extends in a direction essentially perpendicular to the surface 241 and thus represents an outer boundary of the first component 231, beyond which no production material may be moved from the interior of the material hopper 201. The flexible or movable element 242 may, for example, be configured as a rotatably mounted sheet metal plate which may be tilted in the direction of the interior space of the material hopper, but which does not move beyond a certain end position in the opposite direction, i.e., in the direction of the exterior. This ensures that a feeder vehicle may, for example, enter the vicinity of the first component with its trailer coupling by tilting the plate 242 in the direction of the interior space. This allows the distance between the feeder vehicle and the material hopper to be reduced, thus reducing the risk of production material falling out during loading. At the same time, this prevents the material hopper from being damaged by being entered by the trailer coupling.

The plate 242 may also be connected to a spring element, not shown here, which biases the plate 242 into its upright position, as shown here. Tilting of the plate 242 in the direction of the interior space of the material hopper is then possible against the spring force and may be effected, for example, by the trailer coupling described above.

After removal thereof from the material hopper (for example after the material hopper has been filled) the bias of the plate 242 causes it to return to the initial position shown here.

As an alternative to a movably mounted plate, for example, the element 242 may also consist of flexible material or include flexible material. For example, it may be a rubber lip that may be made of polyurethane, for example, or may include an at least outer coating of polyurethane. The flexible element may be made so that in a force-free state, as shown in FIG. 2 by way of example, it assumes the position of the element 242 shown here. The flexible element may then be deformed by the application of force, such as the trailer coupling described, and pushed, for example, in the direction of the interior space of the material hopper, so that, for example, a part of the feeder vehicle, such as the trailer coupling, may penetrate into this area.

While described here only in connection with the first component 231, corresponding designs of the second component may also be provided.

In the embodiment shown here, it is provided that the surface 241 of the first component in the open position of the first component is in a lower position than the corresponding surfaces of the second components 232 and 233, respectively. While this may be sufficient to prevent damage to the material hopper, it may alternatively or additionally be provided that, if the first component has an immovable outer boundary surface in the form of the element 242, this element includes an upper edge 291 that is positioned lower or deeper than the corresponding upper edges 292 of the second component. This may prevent production material from falling out, while at the same time reducing damage to the material hopper.

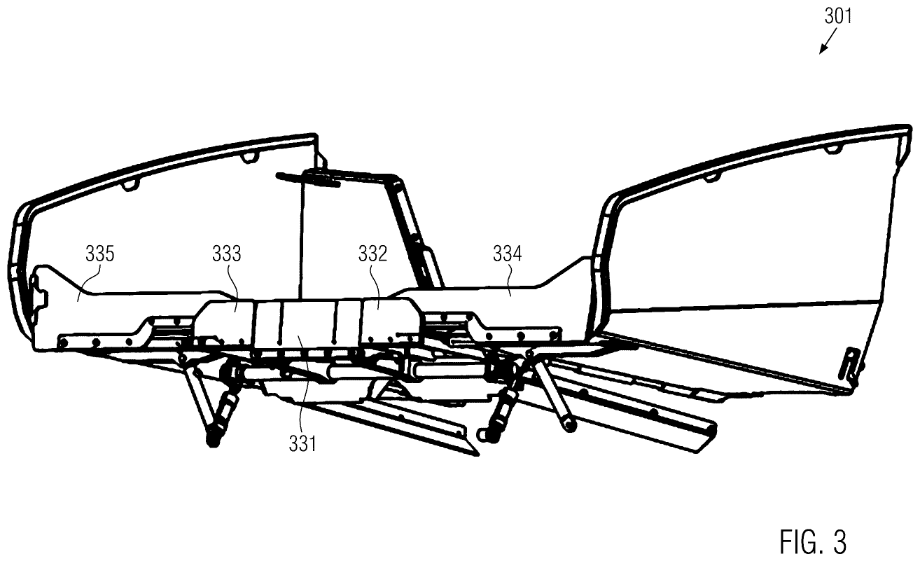

FIGS. 3 to 5 schematically show a sequence of movements for closing the material hopper and in particular for moving the multi-component flap from the open position to the closed position. In FIG. 3, the material hopper 301 is shown in the open position. In this context, this means that the multi-component flap, including the first component 331 and the second component 332, 333, is arranged in its open position. As already described, the disclosure provides that in this open position the first component is positioned lower than the second component of the flap, so that damage, for example by a lower-lying component of a feeder vehicle, may be avoided.

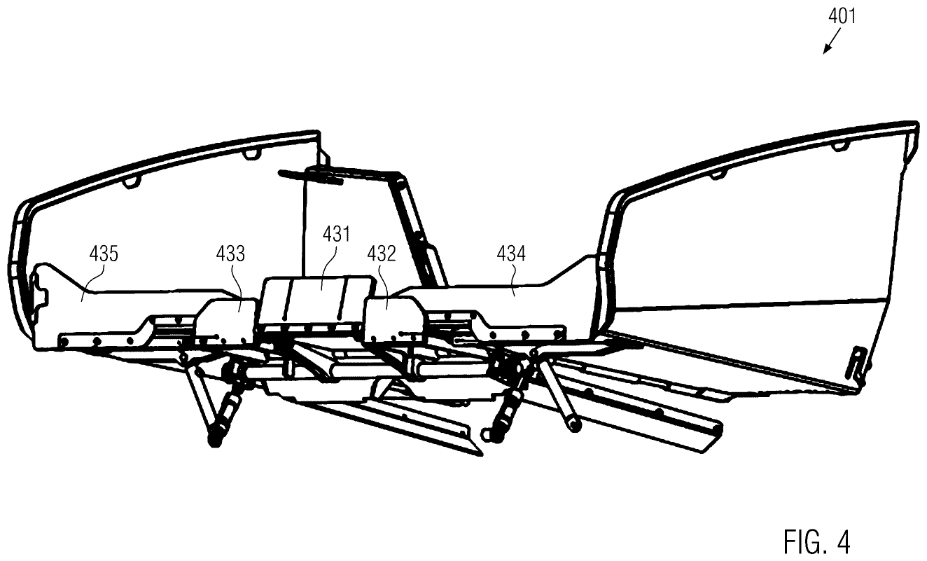

If the material hopper is to be closed, the multi-component flap has to be moved from its open position to the closed position. In FIG. 4 an intermediate step is shown. In FIG. 4, the first component 431 is moved from its open position in the direction of the closed position. As already described, this may be done, for example, by rotating the first component about an axis of rotation. As can be seen, the position of the second component does not change as a result of the movement of the first component. The path or distance covered by the first component 431 from FIG. 3 to FIG. 4, starting from the open position, is thus achieved in this embodiment without the second component moving. The first distance covered may, for example, be chosen so that the first component and the second component are at the same height at the end of this distance. In this position, the follower (see FIG. 1) may then cause the second component 432, 433 to be driven so that it follows the movement of the first component 431 in the direction of the closed position.

If no follower is provided, but instead a drive element is considered for each of the first component and the second component, it may be provided that the movement of the first component and of the second component is controlled by actuation of the drive elements in such a way that the second component only moves after the first component has covered the first distance. During the second distance, the first component and the second component then move in a motion-coupled manner.

The second distance may, but does not have to, include the entire distance to be covered by the first and/or second component to reach the closed position. For example, it may be provided that the closed position of the second component is reached before the closed position of the first component is reached, so that after the movement of the second component has ended, the first component is still moved. It may also be provided that the first component 431 reaches its closed position before the second component 432, 433 reaches its closed position.

In FIG. 4, not only the second component 432, 433 has not been moved further, but also the wing surfaces 434 and 435, which, according to the description of FIG. 2, may optionally be provided, remain in their open positions. As described, these are only examples and do not necessarily have to be provided. Likewise, it is not necessary for these components to be motion-coupled with the multi-component flap. Their movement may therefore also take place independently of the movement of the components of the multi-part flap.

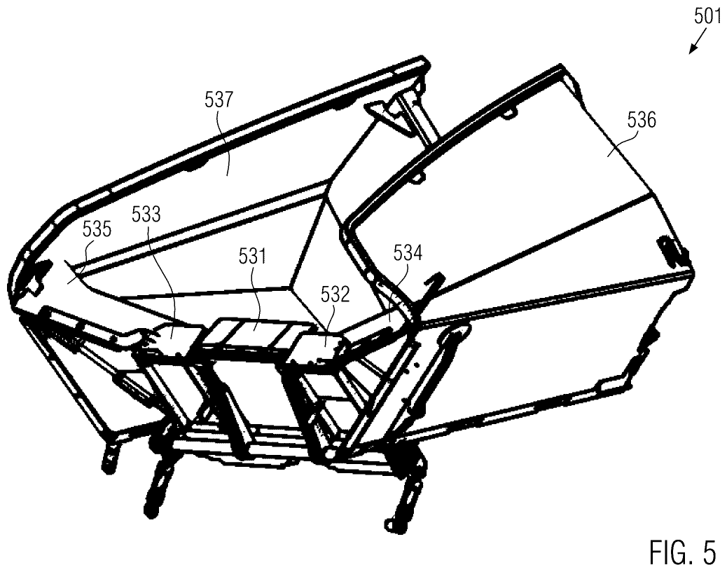

Finally, FIG. 5 shows the closed position of the storage bin. As can be seen, the first component 531 and the second component 532, 533 were moved further in the direction of the interior space of the material hopper around the axis of rotation, starting from FIG. 1. The side surfaces 534 and 535 have now also been moved into their closed position and the elements 536 and 537, which have already been described in relation to FIG. 2 as elements 236 and 237, have been folded towards the interior space of the material hopper so that the interior space of the material hopper is bounded as completely as possible and no material may fall out.

What is claimed is:

1. A road paver comprising a material hopper for receiving production material, the material hopper comprising an outer boundary that at least partially separates an interior space of the material hopper from surroundings, and the material hopper configured to be loaded with production material, wherein the boundary comprises a multi-component flap for closing the material hopper, wherein a first movable component of the flap in an open position is positioned lower than a second movable component of the flap in an open position, and wherein movement of the first component and the second component from the open position to a closed position, in which the material hopper is closed, is at least partially motion-coupled.

2. The road paver according to claim 1, wherein the first component comprises a first upper edge of a first outer boundary surface and the second component comprises a second upper edge of a second outer boundary surface, and wherein in the open position the first upper edge is positioned lower than the second upper edge.

3. The road paver according to claim 1, wherein the first component is rotatably mounted about a first axis of rotation for movement from the open to the closed position and wherein the second component is rotatably mounted about a second axis of rotation for movement from the open to the closed position.

4. The road paver according to claim 3, wherein the first axis of rotation and the second axis of rotation are parallel to one another.

5. The road paver according to claim 3, wherein the first axis of rotation and the second axis of rotation form an angle with one another.

6. The road paver according to claim 3, wherein the first axis of rotation and the second axis of rotation are identical.

7. The road paver according to claim 1, wherein the first component comprises a follower that is configured to engage the second component and to drive the second component with the first component.

8. The road paver according to claim 1, wherein the second component comprises two flap elements arranged on opposite sides of the first component.

9. The road paver according to claim 1, wherein the movement of the first component and/or the movement of the second component are effected by a drive element.

10. The road paver according to claim 9, wherein the drive element comprises a hydraulic drive element, a mechanical drive element or an electric drive element.

11. The road paver according to claim 1, wherein in the open position a maximum distance of a point of the first component to ground is less than 50 cm.

12. The road paver according to claim 1, wherein in the open position a maximum distance of a point of the first component to ground is less than 30 cm.

13. The road paver according to claim 1, wherein the first component and the second component are motion-coupled to each other such that a movement of the first component over a first distance from the open into the closed position occurs without a co-movement of the second component and wherein a movement of the first component over a second distance, covered after the first distance from the open to the closed position, occurs with co-movement of the second component.

14. The road paver according to claim 1, wherein the first component comprises a flexible or movable element which, in the open position of the first component, extends at least partially in a vertical direction and, by application of force, is tiltable in a direction of the interior space of the material hopper.

15. The road paver according to claim 1, wherein the first component and/or the second component comprise/comprises a surface which, in the open position, is inclined towards the interior space.

16. A combination of a feeder vehicle and the road paver according to claim 1, wherein the feeder vehicle enables supply of production material to the material hopper and enables, during the supply of production material, the multi-component flap to be arranged in the open position and, after the supply of production material, to be transferred into the closed position.

17. A method for loading production material into a material hopper of a road paver according to claim 1, wherein the method comprises positioning the multi-component flap in the open position, then positioning a feeder vehicle for supplying production material and supplying production material to the material hopper, moving the feeder vehicle at least partially away from the material hopper and then moving the multi-component flap into the closed position.
